(19) United States
(12) Patent Application Publication
(10) Pub. No.: US 2013/0114007 A1
(43) Pub. Date: May 9, 2013

(54) AUTO-STEREOSCOPIC MULTI-DIMENSIONAL DISPLAY COMPONENT AND DISPLAY THEREOF

(71) Applicants: Hui-Hsiung LIN, Toufen Township (TW); Chien-Yue CHEN, Douliu City (TW); Qing-Long DENG, Taipei City (TW)

(72) Inventors: Hui-Hsiung LIN, Toufen Township (TW); Chien-Yue CHEN, Douliu City (TW); Qing-Long DENG, Taipei City (TW)

(73) Assignee: INDUSTRIAL TECHNOLOGY RESEARCH INSTITUTE, Hsinchu (TW)

(21) Appl. No.: 13/538,897

(22) Filed: Jun. 29, 2012

(30) Foreign Application Priority Data
Nov. 7, 2011 (TW) 100140604

(51) Int. Cl. G02F 1/13357

(52) U.S. Cl. 349/15

(57) ABSTRACT

An auto-stereoscopic multi-dimensional display component is applicable for receiving and splitting a backlight source into waveband lights, and the waveband lights can be refracted to different positions of colored pixels. The multi-dimensional display component comprises a color grating element and a light guiding element; wherein the color grating element is configured to split and refract the backlight source, while the light guiding element emits the waveband lights towards the corresponding pixel positions. When the auto-stereoscopic multi-dimensional display component is applied in an image display device, it becomes a device of different dimensions according to its spectroscopical position.

### CROSS-REFERENCE TO RELATED APPLICATIONS

This non-provisional application claims priority under 35 U.S.C. §119(a) on Patent Application No(s). 100140604 filed in Taiwan, R.O.C. on Nov. 7, 2011, the entire contents of which are hereby incorporated by reference.

### BACKGROUND

1. Technical Field

The present disclosure relates to a multi-dimensional display component and more particularly to an auto-stereoscopic multi-dimensional display component.

2. Related Art

Three-dimensional display technology is flourishing as it is becoming more popular and commercialized. An auto-stereoscopic technology is a type of three-dimensional display technologies, and it provides a convenience that viewers do not need to wear any auxiliary tools to view images presented by the auto-stereoscopic technology. Many are dedicated to researching the technology.

Most conventional auto-stereoscopic displays use parallactic barrier or lenticular design, and the former employs a periodic grating disposed on a flat display. Because the periodic grating has alternate light transmitting and non-light transmitting vertical stripes, images shown by the display are transmitted to a user's left and right eyes as left and right images via the grating, and thus a stereo-effect is presented. For the barrier technology, only approximately 22% of the brilliance of the panel remains because half of the entire grating area is occupied by the non-light transmitting vertical stripes.

The lenticular design of the latter employs the principle of geometrical optics, the left and right images displayed by the panel are respectively focused in the user's left and right eyes. Even though the problem with the reduced brilliance is improved by this method, problems with crosstalk of images and Moiré effect still exist.

Even though the auto stereoscopic technology is being researched and developed continuously, the aforementioned problems with brilliance, crosstalk and overlapping patterns still exist.

### SUMMARY

According to an embodiment of the disclosure, the auto-stereoscopic multi-dimensional display component is applicable for receiving a backlight source and guiding it to a liquid crystal module, the liquid crystal module has a plurality of pixels, each of the pixels comprises a first sub-pixel, a second sub-pixel and a third sub-pixel, the auto-stereoscopic multi-dimensional display component comprises a color grating and a light guiding element. The color grating is for receiving the backlight source and splits the light from the light source into first, second and third waveband lights according to an optical wavelength of the backlight source. The color grating is disposed in the manner of mirror symmetry by a normal plane where the neighboring pixels are connected. The light guiding element is for receiving and guiding the first, the second and the third waveband lights for making the first guided waveband light pass through the first sub-pixel, the second guided waveband light pass through the second sub-pixel, and the third guided waveband light pass through the third sub-pixel.

According to an embodiment of the disclosure, an auto-stereoscopic multi-dimensional display is formed by combining the auto-stereoscopic multi-dimensional display component with a backlight module and a liquid crystal module

The structure and the technical means adopted by the present disclosure to achieve the above and other objects can be best understood by referring to the following detailed description of the embodiments and the accompanying drawings.

### BRIEF DESCRIPTION OF THE DRAWINGS

The present disclosure will become more fully understood from the detailed description given herein below for illustration only, and thus are not limitative of the present disclosure, and wherein:

FIG. 1 is a perspective view of a first embodiment of an auto-stereoscopic multi-dimensional display component according to the disclosure being applied with a liquid crystal module;

FIG. 2A is a partial enlarged view of an auto-stereoscopic multi-dimensional display component of FIG. 1;

FIG. 2B is a side view of an auto-stereoscopic multi-dimensional display component of FIG. 1 being combined with a liquid crystal module;

FIG. 3A is an illustration of optical paths of an auto-stereoscopic stereo display effect of a first embodiment of an auto-stereoscopic multi-dimensional display component according to the disclosure being applied in a liquid crystal module;

FIG. 3B is an illustration of optical paths of a dual-dimensional display effect of a first embodiment of an auto-stereoscopic multi-dimensional display component according to the disclosure being applied in a liquid crystal module;

FIG. 4 is a structural view of a second embodiment of an auto-stereoscopic multi-dimensional display component according to the disclosure;

FIG. 5 is a structural view of a third embodiment of an auto-stereoscopic multi-dimensional display component according to the disclosure; and

FIG. 6 is a structural view of a fourth embodiment of an auto-stereoscopic multi-dimensional display component according to the disclosure.

### DETAILED DESCRIPTION

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

Secondly, in the drawings of the disclosure, the specific elements are enlarged euphuistically for convenience of descriptions, thus the proportions between each of the elements are not drawn according to their dimensions, so that the shapes of the elements can be clearly shown, and the way the drawings being drawn should not be construed as limitative of the disclosure thereof.

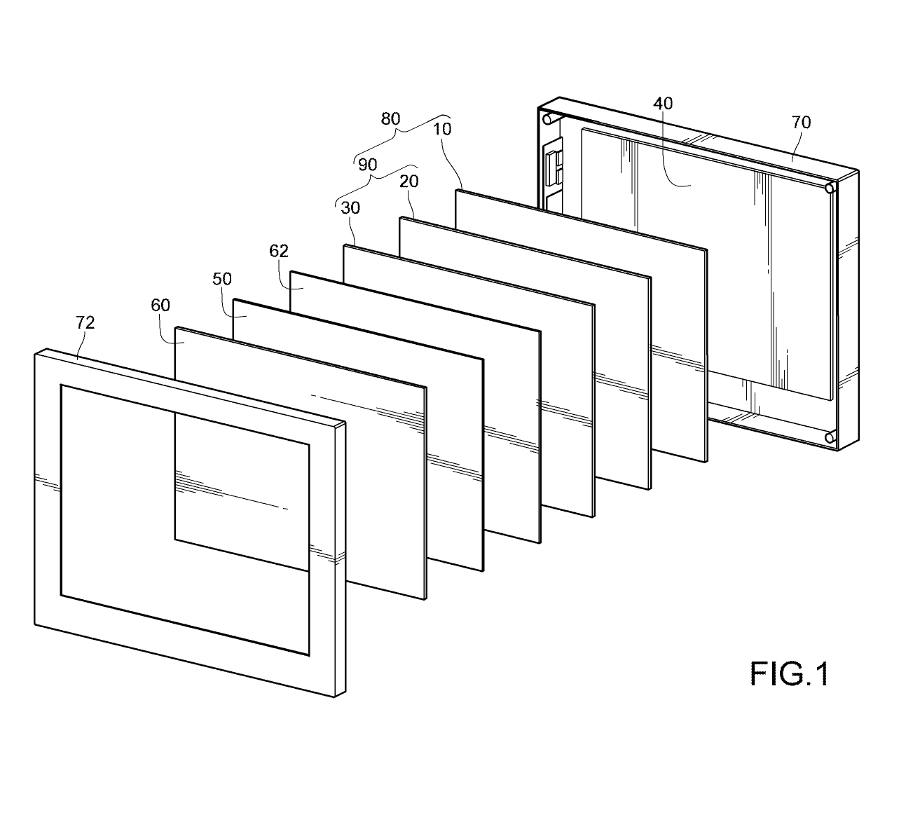

FIG. 1 is a perspective view of a first embodiment of an auto-stereoscopic multi-dimensional display component according to the disclosure being applied with a liquid crystal module. An auto-stereoscopic multi-dimensional display shown in FIG. 1 comprises a back case 70, a backlight module 40, an auto-stereoscopic multi-dimensional display component 80, a back glass 62, a liquid crystal module 50, a front glass 60 and a front case 72.

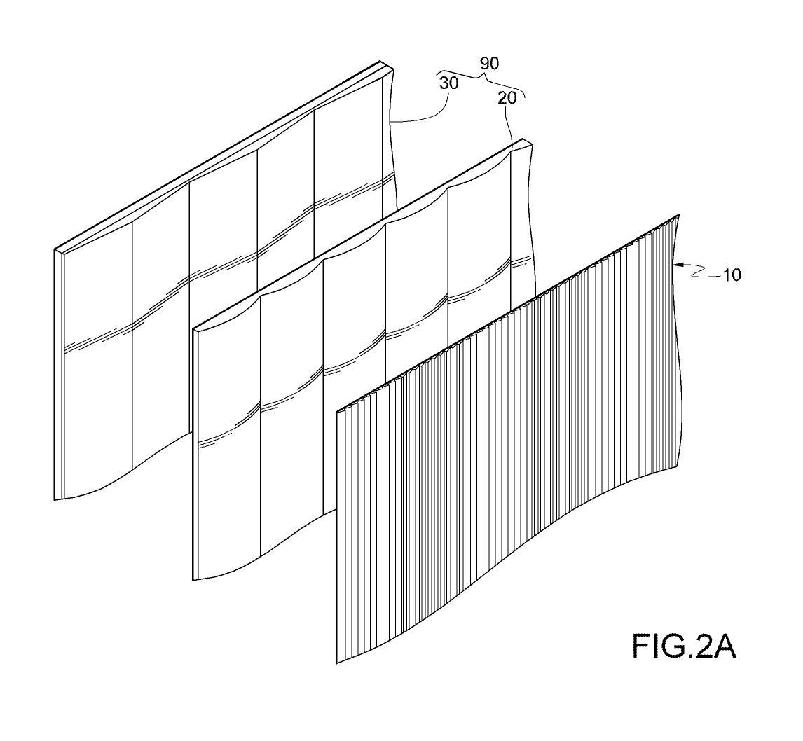

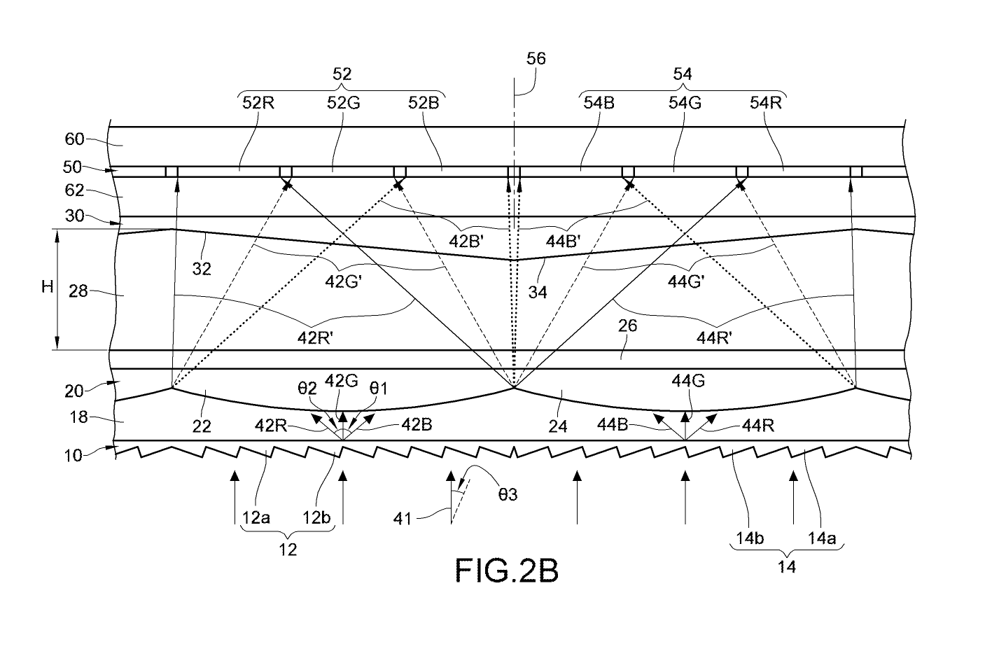

The backlight module 40 generates a backlight source and faces to the auto-stereoscopic multi-dimensional display component 80. The backlight source can be a collimated light, and its collimated angle (referring to θ3 in FIG. 2B) can be between 0 degree and 20 degrees. The collimated angle herein is an included angle between an axial direction of the backlight source and each of the light beams. The size of the collimated angle depends on the auto-stereoscopic multi-dimensional display component 80 in order to have fine image quality and to reduce the occurrence of crosstalk. The multi-dimension mentioned herein can be, but not limited to dual-dimension, stereoscopy, and above three-dimension. In this embodiment, three-dimensional stereoscopic display is used as an example, and it should not be construed as a limitation to practical applications. When the auto-stereoscopic multi-dimensional display component 80 is applied with the liquid crystal module 50, an auto-stereoscopic effect can be presented for human eyes, or visual images of different contents can be displayed for human eyes at different positions.

The liquid crystal module 50 comprises a plurality of pixels, Each of the pixels comprises a first sub-pixel, a second sub-pixel and a third sub-pixel. This will be described in details later.

The auto-stereoscopic multi-dimensional display component 80 comprises a color grating 10 and a light guiding element 90. The color grating 10 receives the backlight source and splits it into a first, a second and a third waveband lights according to an optical wavelength of the backlight source (it will be described in details later). The light guiding element 90 receives and guides the first, the second and the third waveband lights, so as to guide the first waveband light through the first sub-pixel, guide the second waveband light through the second sub-pixel, and guide the third waveband light through the third sub-pixel. By the light guiding element 90, the waveband lights (including the first, the second and the third waveband lights) passed through the adjacent pixels can be converged at a viewer's left and right eyes at a specific distance from the auto-stereoscopic multi-dimensional display respectively. Therefore, when left and right multi-dimensional (stereo) images are respectively shown in the adjacent pixels of the liquid crystal module 50, a displaying effect of multi-dimensional (stereo) images can be presented for the viewer.

A detailed structure of the auto-stereoscopic multi-dimensional display component 80 can be best understood by referring to FIGS. 2A and 2B. FIG. 2A is a partial enlarged view of the auto-stereoscopic multi-dimensional display component 80 of FIG. 1. FIG. 2B is a side view of the auto-stereoscopic multi-dimensional display component 80 of FIG. 1 being combined with the liquid crystal module 50.

According to this embodiment, the liquid crystal module 50 comprises a plurality of pixels 52 and 54, for convenience of descriptions, a first pixel 52 and a second pixel 54 are used for descriptions respectively, but it should not be construed as a limitation to the disclosure thereof, as the disclosure further comprises other pixels. The first pixel 52 and the second pixel 54 are disposed adjacent to each other, the first pixel 52 comprises a first sub-pixel 52R, a second sub-pixel 52G and a third sub-pixel 52B. The first sub-pixel 52R displays the red color (grayscale) of the first pixel 52, the second sub-pixel 52G displays the green color (grayscale) of the first pixel 52, while the third sub-pixel 52B displays the blue color (grayscale) of the first pixel 52. By the same token, the second pixel 54 comprises a first sub-pixel 54R, a second sub-pixel 54G and a third sub-pixel 54B. As shown in the drawing, the sub-pixels 52R, 52G and 52B of the first pixel 52 and the sub-pixels 54R, 54G and 54B of the second pixel 54 are disposed in the manner of mirror symmetry, but it should not be construed as a limitation to the disclosure thereof. The disposition of mirror symmetry herein can be referred to using a normal plane 56 (a vertical direction as shown in FIG. 2B) where the neighboring pixels such as the first pixel 52 and the second pixel 54 are connected for mirroring of symmetry.

Although the first pixel 52 having three sub-pixels (the sub-pixels 52R, 52G, 52B) and the second pixel 54 also having three sub-pixels (the sub-pixels 54R, 54G, 54B) are taken as an example for descriptions, but it should not be construed as a limitation to the disclosure thereof, four or more than four sub-pixels can also be used in one pixel in other embodiments.

The auto-stereoscopic multi-dimensional display component 80 comprises the color grating 10, a convergent element 20 and a refractive element 30. The aforementioned light guiding element 90 is composed of the convergent element 20 and the refractive element 30.

The color grating 10 is disposed in the manner of mirror symmetry by the normal plane 56 where the neighboring pixels such as the first pixel 52 and the second pixel 54 are connected. In detail, the color grating 10 comprises a plurality of micro prism arrays 12 and 14, wherein the micro prism arrays 12 comprises micro prisms 12a, 12b, and the micro prism arrays 14 comprises micro prisms 14a, 14b. And the adjacent micro prism arrays 12 and 14 are disposed in the manner of mirror symmetry and corresponded to the first pixel 52 and the second pixel 54 respectively. More specifically, the symmetrical mirroring of the adjacent micro prism arrays 12 and 14 can be referred to using the normal plane 56 where the first pixel 52 and the second pixel 54 are connected for mirroring of symmetry. In an embodiment, a period of each of the micro prism arrays 12 and 14 can be between 0.1λ and 10λ, wherein λ is a wavelength of the waveband lights, λ can be a wavelength range of visible light, such as between 380 and 760 nanometers. In this embodiment, a period of each of the micro prism arrays 12 and 14 can be between 40 nm and 10 μm, in other words, a length in a horizontal direction of each of the micro prisms 12a, 12b, 14a and 14b in FIG. 2B can be between 40 nm and 10 μm. Furthermore, a period of the color grating 10 can be between 100 nm and 100 μm.

The color grating 10 receives the backlight source 41 emitted by the backlight module 40 and splits it into first waveband lights 42R and 44R, second waveband lights 42G and 44G and third waveband lights 42B and 44B according to an optical wavelength of the backlight source 41. Indications of light beams of the waveband lights 42R, 42G, 42B, 44R, 44G and 44B in the drawing are for illustration only and should be construed as limitation to the disclosure thereof.

An optical wavelength range of the first waveband lights 42R and 44R can be, but not limited to, 615 nm and 635 nm. An optical wavelength range of the second waveband lights 42G and 44G can be, but not limited to, 515 nm and 535 nm. An optical wavelength range of the third waveband lights 42B and 44B can be, but not limited to, 465 nm and 485 nm. As shown in the drawing, the first waveband light 42R, the second waveband light 42G and the third waveband light 42B respectively enters into the convergent element 20 of the light guiding element 90 by travelling along sequentially adjacent first direction, second direction and third direction. An included angle θ2 between the first direction and the second direction is larger than 0.5 degree and smaller than 30 degrees, an included angle θ1 between the second direction and the third direction is larger than 0.5 degree and smaller than 30 degrees. The first, second and third directions mentioned herein are referred to main travelling directions (the travelling directions of most of the waveband light beams) of the corresponding waveband lights, but not to travelling directions of all of the corresponding waveband lights. In an embodiment, relationships between the included angles θ1, θ2 and the aforementioned collimated angle θ3 can be, but not limited to, θ1=θ2, θ1≦θ3. In other words, the included angles θ1 and θ2 are also formed by the first waveband light 44R, the second waveband light 44G and the third waveband light 44B, which will not be mentioned herein again.

The wavelength ranges of the aforementioned waveband lights are not limited to the abovementioned examples, the waveband lights can be waveband lights of cyan, magenta and yellow.

Each of the waveband lights 42R, 42G, 42B, 44R, 44G and 44B enters into the light guiding element 90 subsequently and are received by the convergent element 20.

The convergent element 20 receives and converges the first waveband lights 42R, 44R, the second waveband lights 42G, 44G and the third waveband lights 42B, 44B respectively. The refractive element 30 refracts the first converged waveband lights 42R′, 44R′ (indicated by solid lines) so that they pass through the first corresponding sub-pixels 52R, 54R respectively, refracts the second converged waveband lights 42G′, 44G′ (indicated by broken lines) so that they pass through the second corresponding sub-pixels 52G, 54G respectively, and refracts the third converged waveband lights 42B′, 44B′ (indicated by dotted lines) so that they pass through the third corresponding sub-pixels 52B, 54B respectively. The refracted and converged waveband lights passing through the sub-pixels mentioned herein is not referred to a 100% of the refracted and converged waveband lights is passed through the sub-pixels; and when the embodiment is implemented, an effect of the disclosure can be achieved by allowing a 60% of the refracted and converged waveband lights passing through the sub-pixels by using the light guiding element 90.

After the first waveband lights 42R′, 44R′, the second waveband lights 42G′, 44G′ and the third waveband lights 42B′, 44B′ refracted by the refractive element 30 have passed through the first sub-pixels 52R, 54R, the second sub-pixels 52G, 54G and the third sub-pixels 52B, 54B correspondingly and respectively, they are formed as images at locations, such as the viewer's left and right eyes, which are at a specific distance from the auto-stereoscopic multi-dimensional display; and the adjacent first and second pixels 52 and 54 are formed as images in the viewer's left and right eyes respectively, so that an effect of multi-dimensional (stereo) images is presented.

The convergent element 20 comprises a plurality of lenses 22 and 24. In an embodiment, the lenses can be micro lenses. In this embodiment, the lenses 22 and 24 are convex lenses. Each of the lenses 22 and 24 corresponds to one of the pixels 52 and 54 respectively. In other words, the first lens 22 corresponds to the first pixel 52, the second lens 24 corresponds to the second pixel 54. The adjacent first and second lenses 22 and 24 are disposed in such a way that they are mirrored symmetrically. A period of the first and second lenses 22 and 24 on the convergent element 20 can be, but not limited to between 0.1λ and 2000λ. In another embodiment, a period of the first and second lenses 22 and 24 on the convergent element 20 can be between 40 nm to 1 mm. The period of the first and second lenses 22 and 24 herein is referred to a length (i.e. a horizontal length shown in FIG. 2B) of a base of the first and second lenses 22 and 24. Furthermore, the convex lens can be a uni-dimensional lenticular lens, a dual-dimensional convex curved mirror or a dual-dimensional concave curved mirror, wherein a curved surface of the aforementioned curved mirror can be a paraboloid, a sphere, a hyperboloid, a freeform surface, etc.

Referring to FIG. 2B for details, a first middle layer 18 is further disposed between the color grating 10 and the convergent element 20, the first middle layer 18 can be air or a plastic material, wherein an index of refraction of the plastic material is between 1.0 and 1.45, the plastic material can be such as: an airgel, a fluorinated monomeric composite of fluorinated poly-functional (meth) acrylic esters, nanoporous silica or silsesquioxane, or mesoporous silica, but is not limited to the materials given above. Furthermore, a second middle layer 28 is further disposed between the convergent element 20 and the refractive element 30, the second middle layer 28 can be air, a maximum distance H (i.e. a maximum height of the second middle layer 28) between the convergent element 20 and the refractive element 30 can be between 0.01 mm and 50 mm.

It can be known from FIG. 2B that, the convergent element 20 further comprises a base plate 26, the first and the second lenses 22 and 24 are disposed on the base plate 26. The base plate 26 as well as the first and the second lenses 22 and 24 can be made of a same material or different materials, that means an index of refraction of the base plate 26 can be the same as or different from that of the first and second lenses 22 and 24. The first and the second lenses 22 and 24 can be first and the second lenses 22 and 24 formed by printing on the base plate 26, but are not limited to them. A material of the base plate 26 as well as the first and second lenses 22 and 24 can be, but not limited to a glass, polycarbonate (PC) or polymethylmethacrylate (PMMA).

The refractive element 30 comprises a plurality of adjacent triangular prisms 32 and 34, the triangular prisms 32 and 34 can be disposed on a back glass 62, each of the triangular prisms 32 and 34 corresponds to one of the pixels 52 and 54. As shown in the drawing, the first triangular prism 32 corresponds to the first pixel 52, and the second triangular prism 34 corresponds to the second pixel 54. In an embodiment, the first and second triangular prisms 32 and 34 can be a right angled triangular prism, while the first and second triangular prisms 32 and 34 can also be a micro multilateral refractive element in other embodiments. The bases (i.e. a side in a horizontal direction shown in FIG. 2B) of the first and the second triangular prisms 32 and 34 are connected with each other, coplanar substantially and facing to the liquid crystal module 50, and the adjacent first and second triangular prisms 32 and 34 are disposed in such a way that they are mirrored symmetrically by the normal plane 56. A material of the refractive element 30 can be a polarizing material such as polyvinyl alcohol (PVA) or polymer-dispersed liquid crystal (PDLC) film, but is not limited to them. A period of the first and second triangular prisms 32 and 34 on the refractive element 30 can be between 0.1λ and 2000λ, but is not limited to it; in another embodiment, a period of the first and second triangular prisms 32 and 34 on the refractive element 30 can be between 40 nm and 1 mm.

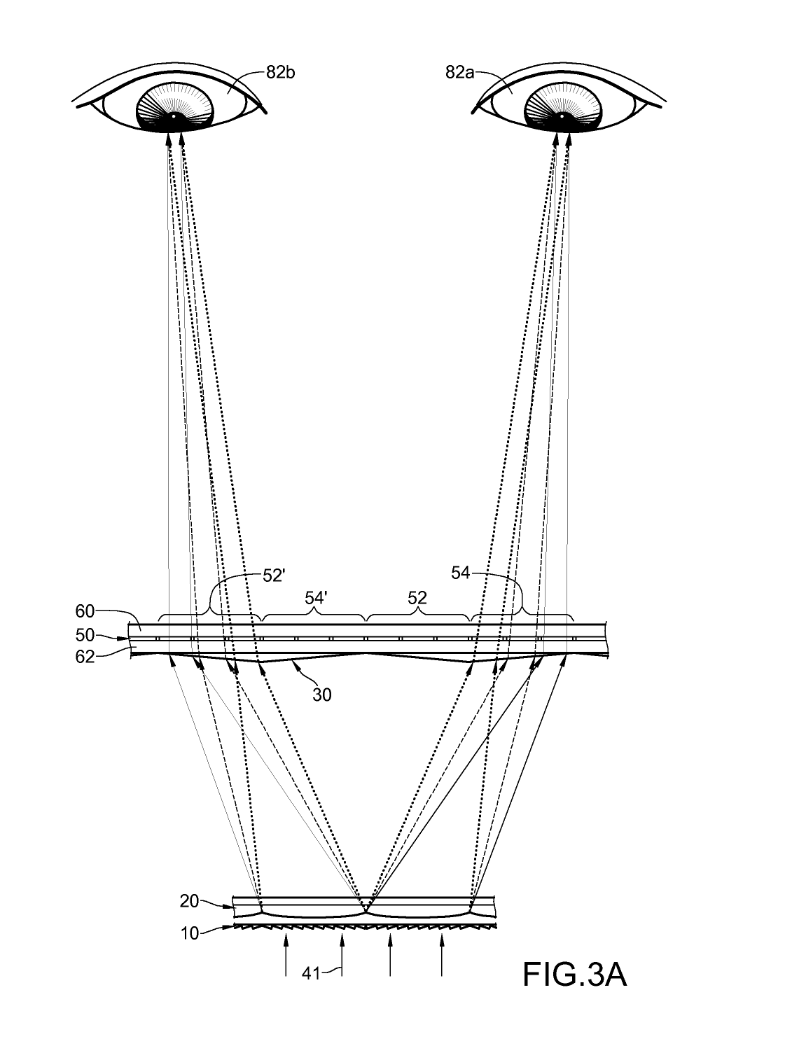

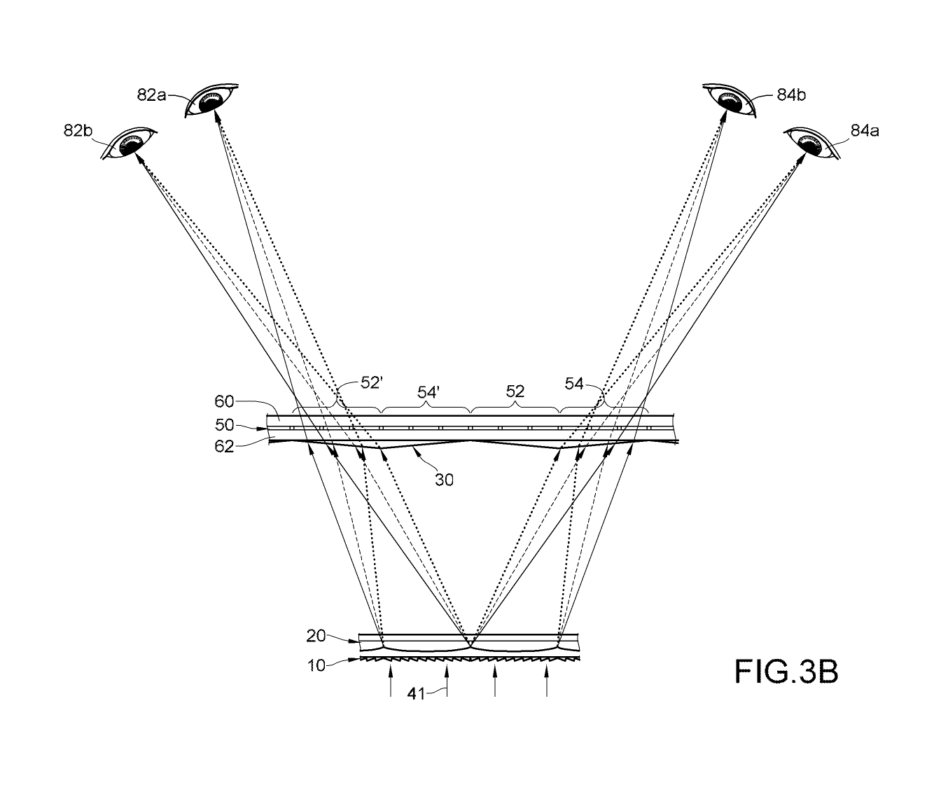

Referring to FIG. 3A, which is an illustration of optical paths of an auto-stereoscopic stereo display effect of a first embodiment of an auto-stereoscopic multi-dimensional display component according to the disclosure being applied in a liquid crystal module. The optical paths in FIG. 3A are illustrated in a way that red lights are indicated by solid lines, green lights are indicated by broken lines, while blue lights are indicated by dotted lines. Only four adjacent pixels 52, 54, 52′ and 54′ are shown in FIG. 3A; images presented by the first pixels 52 and 52′ are a first portion of a stereo-image, while images presented by the second pixels 54 and 54′ are a second portion of the stereo-image. Therefore, after the backlight source 41 is sequentially split, converged and refracted by the color grating 10, the convergent element 20 and the refractive element 30 sequentially, then the two aforementioned portions of the stereo-image can be projected to a viewer's left and right eyes 82a and 82b respectively, thereby, a stereo-perception is created for the viewer.

Referring to FIG. 3B, which is an illustration of optical paths of a dual-dimensional display effect of a first embodiment of an auto-stereoscopic multi-dimensional display component according to the disclosure being applied in a liquid crystal module. Here, only the four adjacent pixels 52, 54, 52′ and 54′ are shown in FIG. 3B, and thus images presented by the first pixels 52 and 52′ are a first image, while images presented by the second pixels 54 and 54′ are a second image, therefore the first image and the second image are different from each other, for example, different movies or different programs, but are not limited to them. As shown in FIG. 3B, after the backlight source 41 is sequentially split, converged and refracted by the color grating 10, the convergent element 20 and the refractive element 30 sequentially, the two aforementioned portions of the stereo-image can be projected to two viewers' left and right eyes 82a, 82b, 84a and 84b respectively. In this way, the first image is seen by the first viewer (corresponding to the eyes 82a and 82b), while the second image is seen by the second viewer (corresponding to the eyes 84a and 84b). Therefore, a dual-dimensional displaying effect can be realized by the auto-stereoscopic multi-dimensional display component. Furthermore, the color grating 10, the convergent element 20 and the refractive element 30 can be designed applicably by the discloser of the disclosure to be used with the pixels 52, 54, 52′ and 54′, thereby more than two images of different pictures can be presented for viewing by many viewers at a same time interval.

According to the abovementioned descriptions, when the auto-stereoscopic multi-dimensional display component 80 is used with the backlight module 40 and the liquid crystal module 50, a multi-dimensional visual effect can be provided for the viewers.

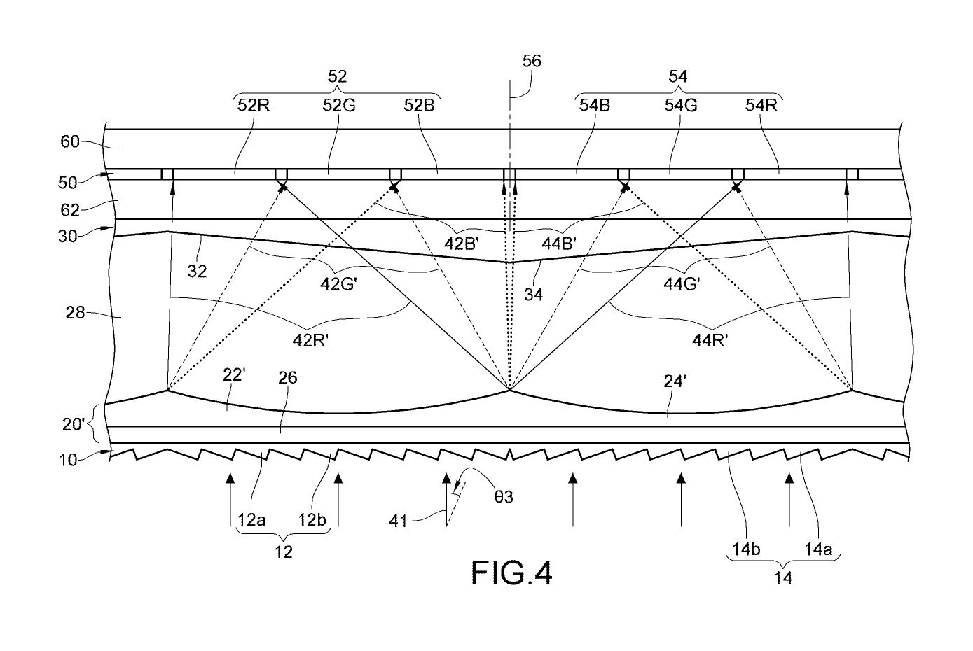

Referring to FIG. 4, which is a structural view of a second embodiment of an auto-stereoscopic multi-dimensional display component according to the disclosure. As shown in the drawing, an auto-stereoscopic multi-dimensional display component comprises the color grating 10, a convergent element 20′ and the refractive element 30. The elements in this embodiment are similar to those of the first embodiment, wherein the convergent element 20′ comprises a plurality of concave lenses 22′ and 24′, the concave lenses 22′ and 24′ are disposed on the base plate 26, and the color grating 10 is also disposed on the base plate 26, the color grating 10 and the concave lenses 22′ and 24′ are disposed on two opposite surfaces of the base plate 26 respectively to form a dual layered structure of films.

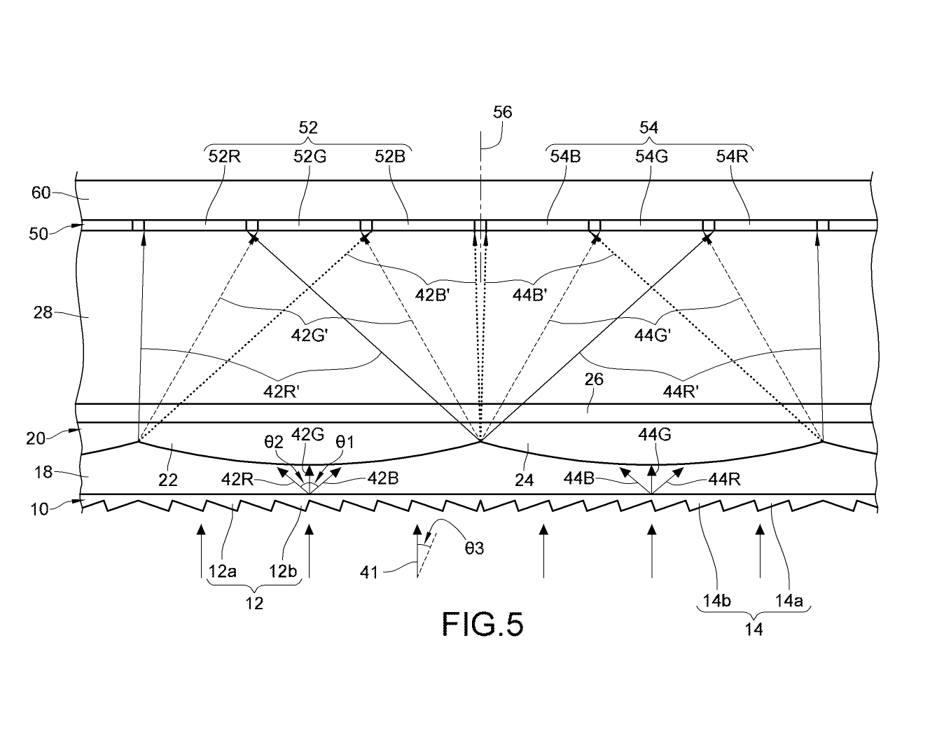

Referring to FIG. 5, which is a structural view of a third embodiment of an auto-stereoscopic multi-dimensional display component according to the disclosure. An auto-stereoscopic multi-dimensional display component of the third embodiment comprises the color grating 10 and the convergent element 20. The difference between the third embodiment and the first embodiment lie in that, the refractive element 30 is omitted in the third embodiment. The refractive element 30 provides a suitable refracting capability for the light guiding element 90. In other words, by a disposition of the refractive element 30 in the first embodiment, distances between the liquid crystal module 50 and the color grating 10, the convergent element 20 are shorter than those in the third embodiment.

In the third embodiment, the convergent element 20 receives and converges the first, the second and the third waveband lights 42R, 44R, 42G, 44G, 42B and 44B, so that the first converged waveband lights 42R and 44R pass through the first corresponding sub-pixels 52R and 54R respectively, the second converged waveband lights 42G and 44G pass through the second corresponding sub-pixels 52G and 54G respectively, and the third converged waveband lights 42B and 44B pass through the third corresponding sub-pixels 52B and 54B respectively. The included angles 01 and 02 between the first waveband lights 42R and 44R, the second waveband lights 42G and 44G and the third waveband lights 42B and 44B after split by the color grating 10 can be less than 1 degree. The color grating 10 comprises a plurality of micro prism arrays, and a period of each of the micro prism arrays is between 6 microns and 60 microns.

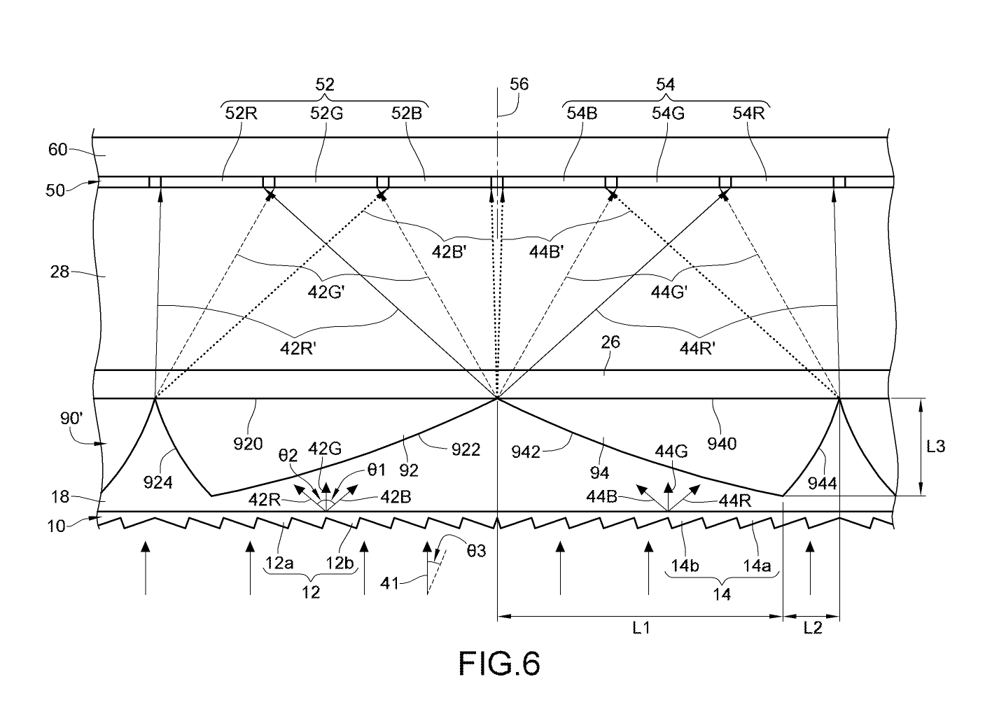

Referring to FIG. 6, which is a structural view of a fourth embodiment of an auto-stereoscopic multi-dimensional display component according to the disclosure. An auto-stereoscopic multi-dimensional display component of the fourth embodiment comprises the color grating 10 and a light guiding element 90′. The light guiding element 90′ integrates the convergent element 20 and the refractive element 30 in the first embodiment into a single element. The light guiding element 90′ comprises a plurality of freeform micro composite lenses 92 and 94. Each of the micro composite lenses 92 and 94 corresponds to one of the pixels 52 and 54; each of the micro composite lenses 92 and 94 receives and converges the first waveband lights 42R and 44R, the second waveband lights 42G and 44G and the third waveband lights 42B and 44B correspondingly, so that the first converged waveband lights 42R′ and 44R′ pass through the first corresponding sub-pixels 52R and 54R, the second converged waveband lights 42G′ and 44G′ pass through the second corresponding sub-pixels 52G and 54G, and the third converged waveband lights 42B′ and 44B′ pass through the third corresponding sub-pixels 52B and 54B.

The aforementioned freeform micro composite lenses 92 and 94 can be designed based on requirements of convergence and refraction. In this embodiment, each of the freeform micro composite lenses 92 and 94 corresponds to one of the pixels 52 and 54 respectively; each of the freeform micro composite lenses 92 and 94 receives and converges the first, the second and the third waveband lights 42R, 44R, 42G, 44G, 42B and 44B, so that the first converged waveband lights 42R and 44R pass through the first corresponding sub-pixels 52R and 54R respectively, the second converged waveband lights 42G and 44G pass through the second corresponding sub-pixels 52G and 54G respectively, and the third converged waveband lights 42B and 44B pass through the third corresponding sub-pixels 52B and 54B respectively.

Take the micro composite lens 94 for an example, it is roughly triangular and has three sides 940, 942 and 944, wherein the base 940 is a flat side, the first slant side 942 and the second slant side 944 are curved sides, the first slant side 942 and the second slant side 944 intersects at an apex, a horizontal distance (i.e. a distance the first slant side 942 projected to the base 940) from the apex to another end of the first slant side 942 is L1, a horizontal distance (i.e. a distance the second slant side 944 projected to the base 940) from the apex to another end of the second slant side 944 is L2, a vertical distance (height) from the apex to the base 940 is L3, wherein L1:L2:L3 is approximately 45:1:10, and a radius of curvature of the first slant side 942 is approximately 4250 microns, a length (L1+L2) of the base 940 is approximately 190 microns, a radius of curvature of the second slant side 944 is approximately 4246 microns.

Note that the specifications relating to the above embodiments should be construed as exemplary rather than as limitative of the disclosure, with many variations and modifications being readily attainable by a person of average skill in the art without departing from the spirit or scope thereof as defined by the appended claims and their legal equivalents.

What is claimed is:

1. An auto-stereoscopic multi-dimensional display component, applicable for receiving a backlight source and guiding it to a liquid crystal module, the liquid crystal module having a plurality of pixels, each of the pixels comprising a first sub-pixel, a second sub-pixel and a third sub-pixel, the auto-stereoscopic multi-dimensional display component comprising:
a color grating for receiving the backlight source and splitting light from the backlight source into a first waveband light, a second waveband light and a third waveband light according to an optical wavelength range of the backlight source and the color grating disposes in the manner of mirror symmetry by a normal plane where the neighboring pixels are connected; and
a light guiding element for receiving and guiding the first, the second and the third waveband lights for guiding the first waveband light through the first sub-pixel, guiding the second waveband light through the second sub-pixel, and guiding the third waveband light through the third sub-pixel.

2. The auto-stereoscopic multi-dimensional display component as claimed in claim 1, wherein the light guiding element comprises:
a convergent element for receiving and converging the first, the second and the third waveband lights; and
a refractive element configured to refract the first waveband light converged for making the first waveband light converged pass through the first sub-pixel, to refract the second waveband light converged for making the second waveband light pass through the second sub-pixel, and configured to refract the third waveband light converged for making the third waveband light pass through the third sub-pixel.

3. The auto-stereoscopic multi-dimensional display component as claimed in claim 2, wherein the first waveband light, the second waveband light and the third waveband light enter into the light guiding element by travelling along sequentially adjacent first direction, second direction and third direction respectively, an first included angle between the first direction and the second direction is larger than 0.5 degree and smaller than 30 degrees, an second included angle between the second direction and the third direction is larger than 0.5 degree and smaller than 30 degrees.

4. The auto-stereoscopic multi-dimensional display component as claimed in claim 2, wherein the color grating comprises a plurality of micro prism arrays, a period of each of the micro prism arrays is between 40 nanometers and 10 microns.

5. The auto-stereoscopic multi-dimensional display component as claimed in claim 2, wherein the refractive element comprises a plurality of triangular prisms adjacent to each other, and each of the triangular prisms corresponds to one of the plurality of pixels.

6. The auto-stereoscopic multi-dimensional display component as claimed in claim 5, wherein bases of the triangular prisms are coplanar and face to the liquid crystal module, and the triangular prisms adjacent to each other are disposed in the manner of mirror symmetry by the normal plane.

7. The auto-stereoscopic multi-dimensional display component as claimed in claim 5, wherein a period of the triangular prisms on the refractive element is between 40 nm and 1 mm.

8. The auto-stereoscopic multi-dimensional display component as claimed in claim 2, wherein the convergent element comprises a plurality of lenses, and each of the plurality of lenses corresponds to one of the plurality of pixels.

9. The auto-stereoscopic multi-dimensional display component as claimed in claim 8, wherein a period of the lenses on the convergent element is between 40 nm and 1 mm.

10. The auto-stereoscopic multi-dimensional display component as claimed in claim 2, further comprises a first middle layer disposed between the color grating and the convergent element, wherein the first middle layer is formed of air or a plastic material, and wherein an index of refraction of the plastic material is between 1.0 and 1.45.

11. The auto-stereoscopic multi-dimensional display component as claimed in claim 2, further comprises a second middle layer disposed between the convergent element and the refractive element, wherein the second middle layer is formed of air.

12. The auto-stereoscopic multi-dimensional display component as claimed in claim 11, wherein a maximum height of the second middle layer is between 0.01 mm and 50 mm.

13. The auto-stereoscopic multi-dimensional display component as claimed in claim 1, wherein the light guiding element is a convergent element, the convergent element is configured to receive and converge the first, the second and the third waveband lights for making the first waveband light converged pass through the first sub-pixel, the second waveband light converged pass through the second sub-pixel, and the third waveband light converged pass through the third sub-pixel.

14. The auto-stereoscopic multi-dimensional display component as claimed in claim 13, wherein when the first, the second and the third waveband lights travel along sequentially adjacent first, second and third directions respectively, an first included angle between the first direction and the second direction is smaller than 1 degree, and an second included angle between the second direction and the third direction is smaller than 1 degree.

15. The auto-stereoscopic multi-dimensional display component as claimed in claim 14, wherein the color grating comprises a plurality of micro prism arrays, and a period of each of the micro prism arrays is between 6 microns and 60 microns.

16. The auto-stereoscopic multi-dimensional display component as claimed in claim 1, wherein the light guiding element comprises a plurality of micro composite lenses, each of the micro composite lenses corresponds to one of the pixels, each of the micro composite lenses is configured to receive and converge the first, the second and the third waveband lights for making the first waveband light converged pass through the first sub-pixel, the second waveband light converged pass through the second sub-pixel, and the third waveband light converged pass through the third sub-pixel.

17. The auto-stereoscopic multi-dimensional display component as claimed in claim 16, wherein each of the micro composite lens is roughly triangular and has a base, a first slant side and a second slant side, the first slant side and the second slant side intersects at an apex, a distance the first slant side projected to the base is L1, a distance the second slant side projected to the base is L2, and a vertical distance from the apex to the base is L3, wherein L1:L2:L3 is 45:1:10.

18. The auto-stereoscopic multi-dimensional display component as claimed in claim 1, wherein a period of the color grating is between 100 nanometers and 100 microns.

19. An auto-stereoscopic multi-dimensional display, comprising:
a backlight module generating a backlight source;
a color grating for receiving the backlight source and splitting light from the backlight source into a first waveband light, a second waveband light and a third waveband light according to an optical wavelength range of the backlight source;
a liquid crystal module having a plurality of pixels, each of the plurality of pixels comprises a first sub-pixel, a second sub-pixel and a third sub-pixel; and
a light guiding element for receiving and guiding the first, the second and the third waveband lights for guiding the first waveband light through the first sub-pixel, guiding the second waveband light through the second sub-pixel, and guiding the third waveband light through the third sub-pixel;
wherein the color grating disposes in the manner of mirror symmetry by a normal plane where the neighboring pixels are connected.

20. The auto-stereoscopic multi-dimensional display as claimed in claim 19, wherein the light guiding element comprises:
a convergent element for receiving and converging the first, the second and the third waveband lights; and
a refractive element being configured to refract the first waveband light converged for making the first waveband light passes through the first sub-pixel, being configured to refract the second waveband light converged for making the second waveband light pass through the second sub-pixel, and being configured to refract the third waveband light converged for making the third waveband light pass through the third sub-pixel
wherein the refractive element disposes in the manner of mirror symmetry by the normal plane.

21. The auto-stereoscopic multi-dimensional display component as claimed in claim 20, wherein the first waveband light, the second waveband light and the third waveband light enter into the light guiding element by travelling along sequentially adjacent first direction, second direction and third direction respectively, an first included angle between the first direction and the second direction is equal to an second included angle between the second direction and the third direction, and the first included angle between the first direction and the second direction is smaller than or equal to a collimated angle of the backlight source.
